(19) United States
(12) Patent Application Publication
(10) Pub. No.: US 2025/0348971 A1
(43) Pub. Date: Nov. 13, 2025

(54) Data Augmentation Method and Computing Device Thereof

(71) Applicant: Wistron Corporation, New Taipei City (TW)

(72) Inventor: Guan-Yi Chian, New Taipei City (TW)

(73) Assignee: Wistron Corporation, New Taipei City (TW)

(21) Appl. No.: 18/780,526

(22) Filed: Jul. 23, 2024

(30) Foreign Application Priority Data
May 7, 2024 (TW) 113116850

(51) Int. Cl. G06T 3/18; G06T 5/20; G06T 5/70; G06T 11/00; G06V 10/774

(52) U.S. Cl. CPC G06T 3/18; G06T 5/20; G06T 5/70; G06T 11/00; G06V 10/774; G06T 2207/20081

(57) ABSTRACT

A data augmentation method includes obtaining an input image and creating a plurality of output images corresponding to the input image. At least one first pixel of the input image is displaced to form one output image. The displacement of each first pixel is randomized. This overcomes the challenge when training data is scarce.

### BACKGROUND OF THE INVENTION

### 1. Field of the Invention

The present invention relates to a data augmentation method and a computing device thereof, and more particularly, to a data augmentation method and a computing device, that can, corresponding to one single image, generate a large number of images with sufficient diversity.

### 2. Description of the Prior Art

Computer vision technology (e.g., object or boundary recognition, image reconstruction or enhancement, etc.) allows electronic devices to extract information from images or videos. Moreover, it can be applied in various fields (e.g., medical image processing, advanced driver-assistance systems, automated inspection, etc.). For example, to reduce the need for manual visual inspection, today's industrial production lines can use technologies like automated optical inspection or deep learning to automatically inspect products on a production line for any defects. However, to establish an automated inspection mechanism, it is necessary to collect a sufficient number of normal images and defective images in advance, such that the automated inspection machine can recognize defect standards. However, in the early stages of new product development or new manufacturing processes, collecting a large number of images or images with sufficient diversity is challenging.

As far as image generation is concerned, deep learning technologies (e.g., Generative Adversarial Networks (GANs), Stable Diffusion models, etc.) still require vast amounts of images in advance for model training, so that the trained model can be used to generate images. Moreover, deep learning technology operates like a black box. It is difficult for users to understand how deep learning technology generates images and assess its rationality. Therefore, generating a large number of diverse images remains a critical challenge for existing computer vision technology.

### SUMMARY OF THE INVENTION

It is therefore a primary objective of the present application to provide a data augmentation method and a computing device thereof, to improve over disadvantages of the prior art.

An embodiment of the present invention discloses a data augmentation method, comprising obtaining an input image; and creating a plurality of output images corresponding to the input image, wherein at least one first pixel of the input image is displaced to form one of the output images, and a displacement of each of the at least one first pixel is randomized.

An embodiment of the present invention discloses a computing device, comprising a storage circuit, configured to store an instruction, wherein the instruction comprises obtaining an input image; and creating a plurality of output images corresponding to the input image, wherein at least one first pixel of the input image is displaced to form one of the output images, and a displacement of each of the at least one first pixel is randomized; and a processing circuit, coupled to the storage circuit and configured to execute the instruction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computing device according to an embodiment of the present invention.

FIG. 2 and FIG. 3 are schematic diagrams of local random deformation performed on an input image to generate output images according to embodiments of the present invention.

FIG. 4 is a schematic diagram of overall random deformation performed on an input image to generate output images according to an embodiment of the present invention.

FIG. 5 is a schematic diagram of matrix generation according to an embodiment of the present invention.

FIG. 6 is a schematic diagram of different equivalent displacement degrees according to an embodiment of the present invention.

FIG. 7 is a schematic diagram of different equivalent deformation degrees according to an embodiment of the present invention.

FIG. 8 is a schematic diagram of different equivalent smoothness according to an embodiment of the present invention.

FIG. 9 and FIG. 10 are schematic diagrams deformation performed on an input image to generate output images according to an embodiment of the present invention.

### DETAILED DESCRIPTION

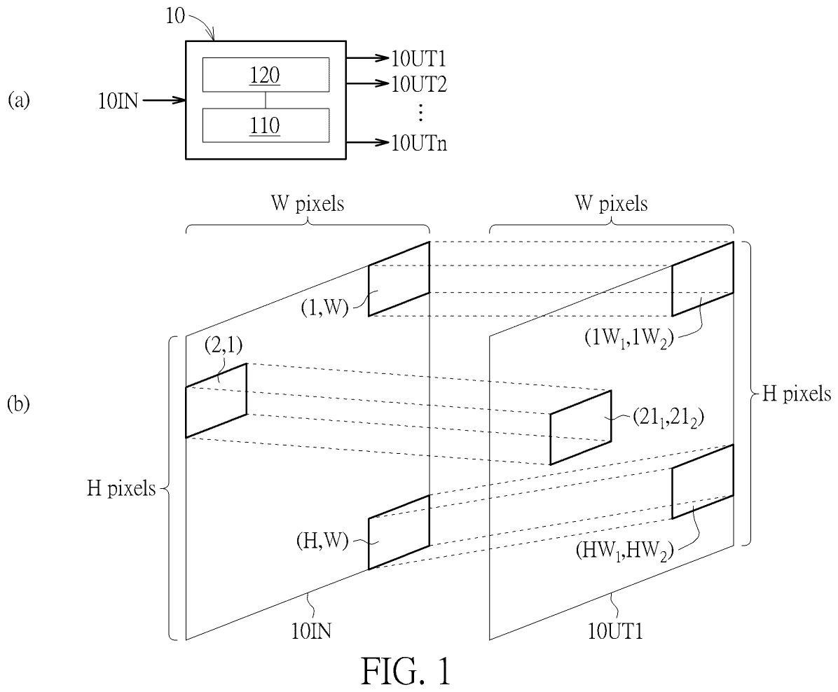

FIG. 1 is a schematic diagram of a computing device 10 according to an embodiment of the present invention. As shown in FIG. 1 (a), the computing device 10 (e.g., a chip, a computer, or a host) may comprise a storage circuit 110 and a processing circuit 120. The computing device 10 and may be deployed in an industrial production line, a drone, or a sensor, etc. Even if the computing device 10 receives only one input image 10IN (e.g., a normal image which is not defective), the computing device 10 may generate multiple output images 10UT1 to 10UTn (e.g., defective images), which correspond to the input image 10IN, through random deformation. The output images 10UT1 to 10UTn may be numerous and exhibit considerable diversity, which helps to enhance the performance of deep learning model(s). In other words, the output images 10UT1 to 10UTn (in terms of the distribution of pixel values) are different from each other and also different from the input image 10IN (in terms of the distribution of pixel values).

In one embodiment, as shown in FIG. 1 (b), an input image (for example, 10IN) can have all or some of its pixels displaced to form an output image (for example, 10UT1) with all or some of its pixels accordingly. The displacement(s) of the pixel(s) may be random. For example, the pixel (2,1) of the image 10IN is shifted to the pixel (21₁,21₂) of the image 10UT1 by a first displacement, with its pixel value remaining unchanged. Besides, the pixel (H,W) of the image 10IN is shifted, by a second displacement, to the pixel (HW₁,HW₂) of the image 10UT1, while its pixel value remains unchanged. Similarly, the pixel value of the pixel (2,1) of the image 10IN remains unchanged but is shifted by a third displacement to form a pixel of the image 10UT2; the pixel value of the pixel (H,W) of the image 10IN remains unchanged but is shifted by a fourth displacement to form another pixel of the image 10UT2. The first to the fourth displacements may be different from each other (which results in diverse output images), or may be independent of each other without correlation. Alternatively, the first displacement may be a random value (relative to at least one of the second to the fourth displacements), or may not be described as a function of at least one of the second to the fourth displacements. In other words, all (or partial) pixel(s) of an input image are randomly transformed/deformed, and may be converted into a large number of output images with sufficient diversity.

The output image has the same size as its corresponding input image. In one embodiment, the input image 10IN and the output images 10UT1-10UTn may be two-dimensional (2D) images (e.g., grayscale images or color images), with image height of H pixels and image width of W pixels. Alternatively, the input image 10IN and the output images 10UT1-10UTn may be three-dimensional (3D) images (e.g., 3D point cloud images or 3D tomography images), with image height, image width, and image depth of H, W, and D pixels, respectively.

In one embodiment, a data augmentation method may be compiled into a program code and used in the computing device 10. The data augmentation method may comprise at least the following steps:

Step S102: Input an input image (e.g., 10IN) to the computing device 10.

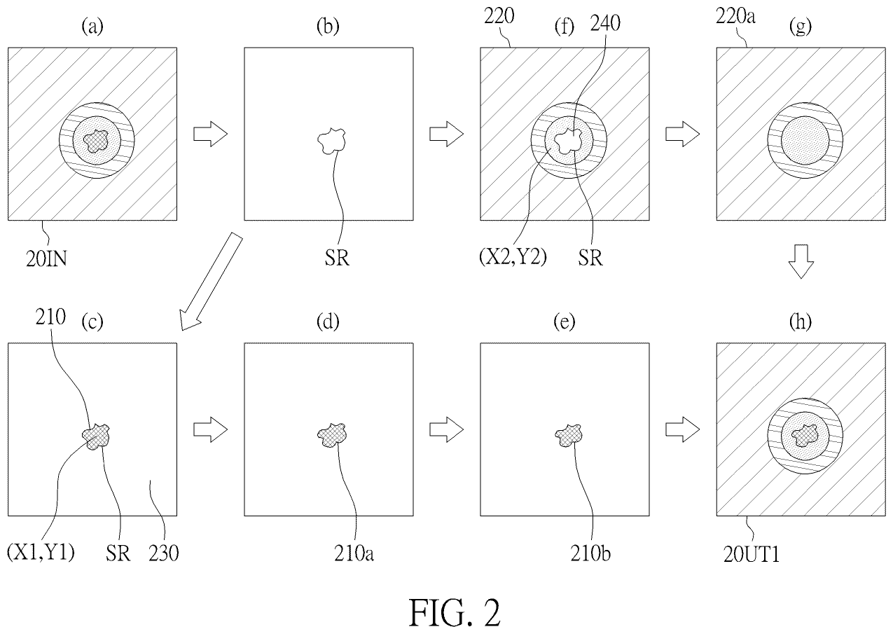

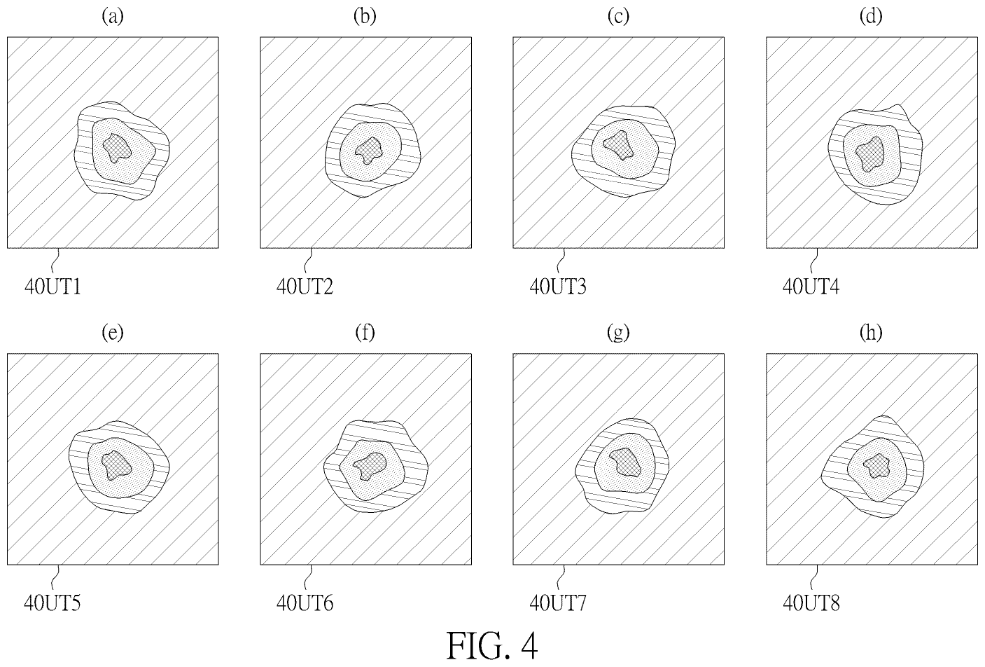

Step S104: The computing device 10 determines whether the input image is divided into multiple first and second pixels. In an embodiment, if the computing device 10 (or the user) marks a region-of-interest (ROI), which is to be randomly deformed, in the input image (e.g., FIG. 2), proceed to step S106. The region-of-interest encloses the first pixels (e.g., (2,1) or (H,W)) inside and differentiates the second pixels (e.g., (1,W)) by positioning the second pixels outside. In another embodiment, if the computing device 10 (or the user) intends to perform random deformation on the entire input image (e.g., FIG. 4), which treats all the pixels of the input image as the first pixels (e.g., (1,W), (2,1), and (H,W)), proceed to step S108.

Step S106: The computing device 10 performs image processing with respect to the second pixels to create a second region image (e.g., 220a in FIG. 2). For example, corresponding to the second pixels, the computing device 10 repairs pixels of the input image, which are enclosed within the region-of-interest or located nearby, to optimize the final effect of produced images. Next, proceed to step S108.

Step S108: The computing device 10 calculates a deformation matrix for the first pixels. Next, step S110 is executed.

Step S110: The computing device 10 performs image processing on the first pixels. For example, the computing device 10 processes the first pixels using the deformation matrix. In an embodiment, if random deformation is performed on part of the input image, the computing device 10 after image processing generates a first region image (e.g., 210a or 210b in FIG. 2), and executes step S112. In another embodiment, if random deformation is performed on the entire input image, the computing device 10 after image processing generates an output image (e.g., 10UT1 in FIG. 1 or 40UT1 in FIG. 4), which corresponds to the input image, and executes step S114 or S116.

Step S112: Based on the first region image (or the first pixels) and the second region image (or the second pixels), the computing device 10 synthesizes an output image (e.g., 10UT1) corresponding to the input image. For example, the computing device 10 integrates the region images by pasting the generated first region image back onto the second region image or by overlaying corresponding pixels of the second region image, which are in the corresponding positions, with the generated first region image. Next, proceed to step S114 or S116.

Step S114: The computing device 10 determines whether to perform step S104 or S108 again to generate additional output images (e.g., 10UT2) corresponding to the input image. Next, proceed to step S116.

Step S116: The computing device 10 uses the input image or the output image to train, verify or test a deep learning model.

One or more of steps S102 to S116 may be removed or reordered according to different needs. In one embodiment, only steps S104, S110 and S112 may be executed, to randomly deform part of the input image; in another embodiment, only step S110 may be executed, to randomly deform the entire input image. In one embodiment, if the second pixels meet certain criteria for bypassing image processing, step S106 may be omitted. In one embodiment, steps S106, S108, or S110 may be executed in a sequence different from the above or in parallel.

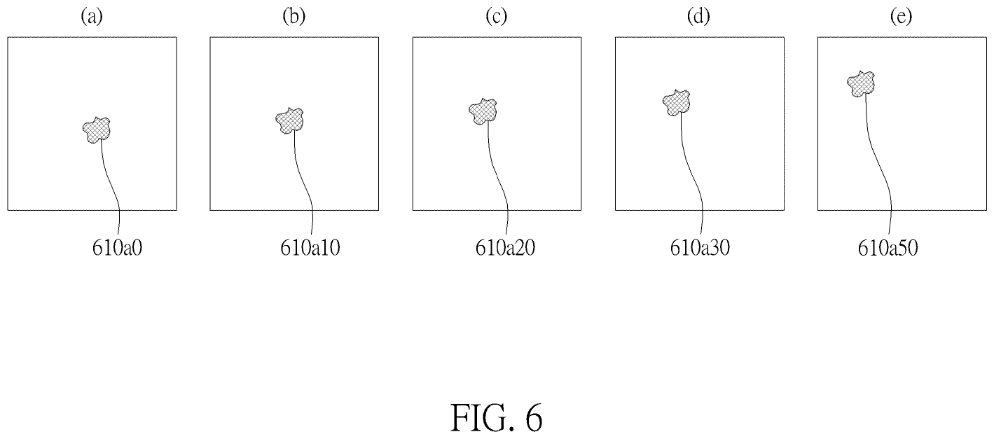

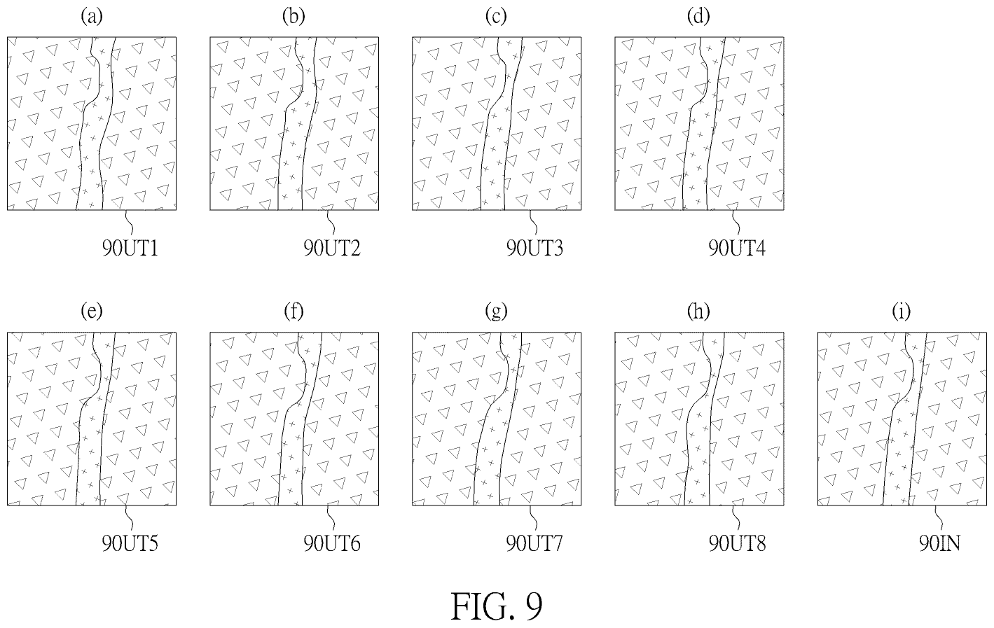

FIG. 2 is a schematic diagram of local random deformation performed on an input image 20IN to generate an output image 20UT1 according to an embodiment of the present invention. The input image 20IN and the output image 20UT1 in FIG. 2 may be used to implement the input image 10IN and the output image 10UT1, respectively. Note that different hatch patterns in figure(s) (e.g., FIG. 2 or 9) may represent different objects, but these hatch patterns are not meant to limit the designs, decorations, or circuitry of the objects. In FIG. 2, slanted cross-hatching represents screw hole(s) or material thereof, dotted hatching represents screw(s) or material thereof, horizontal hatching represents washer(s) or material thereof, and slanted hatching represents printed circuit board(s) or material thereof. In FIG. 2 (or FIGS. 6 to 8), the background is shown in white (without hatching), but in another embodiment, the background could be black.

In step S102, the computing device 10 may obtain the input image 20IN in FIG. 2 (a). In step S104, a user manually marks a region-of-interest SR, which surrounds the first pixels (e.g., (X1, Y1)), from the input image 20IN; alternatively, the computing device 10 automatically marks the region-of-interest SR (e.g., using model(s) like Grounding Dino or Segment anything model). The shape of the region-of-interest SR may be regular (e.g., a rectangle) or irregular (e.g., FIG. 2 (b)). In FIG. 2 (b), both the inside and outside of the region-of-interest SR are white; however, the invention is not limited thereto because the color outside the region-of-interest SR (e.g., black) may differ from that inside the region-of-interest SR (e.g., white). By employing cropping operation, the computing device 10 may use the region-of-interest SR as a mask to crop or extract the first pixels within the region-of-interest SR (i.e., the image 210 in FIG. 2 (c)) and the second pixels outside the region-of-interest SR (e.g., the image 220 in FIG. 2 (f)) from the input image 20IN. As shown in FIG. 2 (c), the region-of-interest SR substantially marks the screw hole to be randomly deformed. The computing device 10 may use the region-of-interest SR to isolate the screw hole image (i.e., 210) within the input image 20IN.

In step S110, the computing device 10 may image-process the image 210 of FIG. 2 (c) to generate the image 210a of FIG. 2 (d). For example, the computing device 10 may spatially transform each first pixel (e.g., (X1,Y1)) within the region-of-interest SR individually, using the deformation matrix calculated in step S108. For example, to change the position of each first pixel without altering its color, the computing device 10 may perform spatial transformation (e.g., deformation) separately on different layers (e.g., the color channel values (R,G,B) of the RGB layer) of each first pixel (e.g., (X1,Y1)).

In step S110, to slightly remove the outermost edge pixels of the image 210a, the computing device 10 may also apply image erosion or edge smoothing. As a result, the image 210b is generated. This randomly deformed image in step S110 may be more suitable for image synthesis. The image 210a or 210b may be used to implement the first region image.

In step S106, to optimize the effect of pasting or merging, the computing device 10 may repair the image 220. This is because the image 210a after random deformation in step S110 may have a different shape from the image 210, causing the image 210a or 210b to potentially be nonmatching or incompatible with the input image 20IN or the image 220. Therefore, directly pasting or combining the image 210a or 210b to the image 20IN or 220 might be undesirable. For example, in step S106, based on the second pixels (e.g., (X2, Y2)) around the region-of-interest SR, the computing device 10 may image-process the image 220 in FIG. 2 (f) to repair, fill, or image-inpaint a background region 240 (shown in white) surrounded by the second pixels. Accordingly, the second region image 220a in FIG. 2 (g) is created. In one embodiment, the background region 240 may be filled by blurring or copying the second pixels around the region-of-interest SR, or by averaging or adding random noise values to the second pixels surrounding the region-of-interest SR, ensuring that the second region image 220a does not comprise the background region 240. In one embodiment, inpainting may be sequential-based, CNN-based, GAN-based, or Fast-Marching-Method-based.

In step S112, to generate the output image 20UT1 (referred to as a composite image), the computing device 10 may paste or combine the eroded image 210b back into the repaired second region image 220a after image-erosion.

In step S116, the computing device 10 may output or provide labeled data or unlabeled data. For example, for an image classification task, the output image provided by the computing device 10 may be considered to comprise certain label(s) (e.g., a defect label). Correspondingly, in step S116, if the deep learning model classifies the output image generated by the computing device 10 into one certain (defect) category, the accuracy is higher. For an image segmentation task, since its deformed area is known, the deformed area (e.g., the defect area, the image 210a, 210b, or the entire output image) may function as a label. Correspondingly, in step S116, if the deep learning model outputs the (defect) area based on the output image, which is generated by the computing device 10, the accuracy is higher.

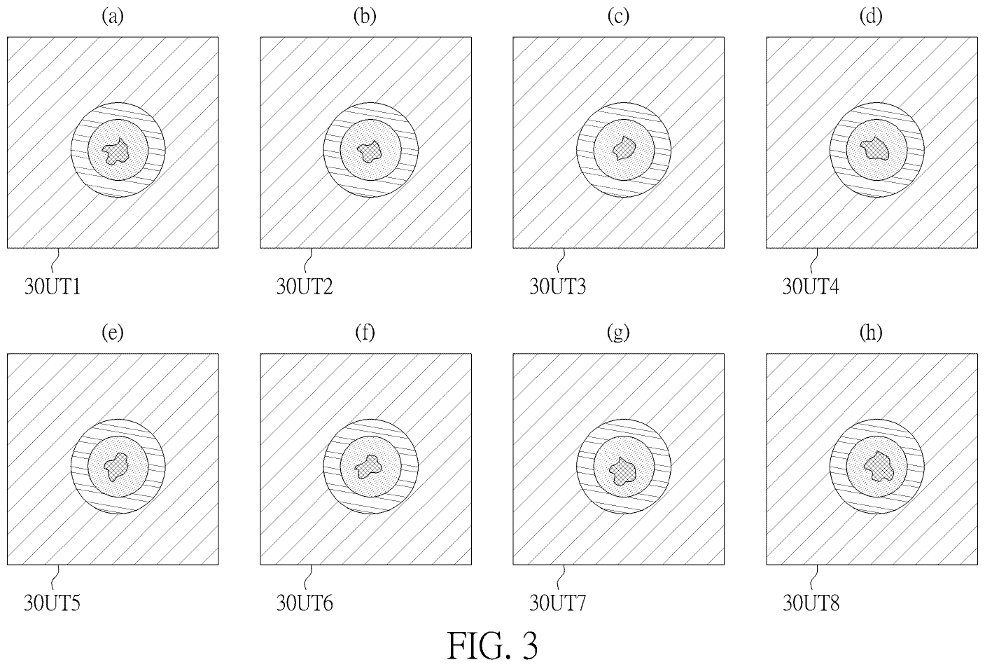

FIG. 3 is a schematic diagram of local random deformation performed on the input image 20IN to generate output image 30UT1 to 30UT8 according to an embodiment of the present invention. Any of the output images 30UT1-30UT8 may be used to implement one of the output images 10UT1-10UTn. As shown in FIGS. 2 and 3, part of the pixels of the input image 20IN are randomly deformed. Accordingly, the input image 20IN may be converted into a large number of output images 20UT1 and 30UT1-30UT8 with sufficient diversity in step S114.

FIG. 4 is a schematic diagram of overall random deformation performed on the input image 20IN to generate output image 40UT1 to 40UT8 according to an embodiment of the present invention. Any of the output images 40UT1-40UT may be used to implement one of the output images 10UT1-10UTn. Without marking a region-of-interest (e.g., SR), the deformation matrix in step S108 may be used to directly perform random deformation on the entire input image 20IN in step S110. This can serve as another data augmentation method. As shown in FIG. 4, all the pixels of the input image 20IN are randomly transformed. Accordingly, the input image 20IN may be converted into a large number of output images 40UT1-40UT8 with sufficient diversity.

In step S116, a large number of images are required for training a deep learning model; however, the quantity or efficiency of output images generated by marking the region-of-interest (e.g., SR) may be insufficient. Compared with the output images 20UT1 or 30UT1-30UT8 generated by marking region-of-interests, the output images 40UT1-40UT8 generated without marking region-of-interests (e.g., SR) may appear less realistic. Nevertheless, the output images 40UT1-40UT8 can increase the number of images available for training. In addition, output images generated without marking region-of-interest(s) may be employed in pretraining of transfer learning. Omitting the step of marking region-of-interest(s) can enhance performance.

In one embodiment, a data augmentation method may be compiled into a program code and used in the computing device 10. The data augmentation method may at least comprise the following steps:

Step S502: The computing device 10 generates a first matrix (e.g., T′ or T″). Next, proceed to step S504, S506, or S508.

Step S504: Using at least one filter, the computing device 10 converts the first matrix into a second matrix (e.g., g(T′)). Next, proceed to step S506 or S508.

Step S506: The computing device 10 vector integrates the first matrix (or the second matrix) to create a third matrix (e.g., ∫g(T′)). Next, proceed to step S508.

Step S508: The computing device 10 determines a deformation matrix (e.g., T) based on the first matrix, the second matrix, or the third matrix. Next, proceed to step S510.

Step S510: According to the deformation matrix, the computing device 10 generates at least one output image (e.g., 10UT1), which corresponds to an input image (e.g., 10IN). Next, proceed to step S512 or S514.

Step S512: The computing device 10 determines whether to execute step S502 again to generate other output image(s) (e.g., 10UT2), which correspond(s) to the input image. Next, proceed to step S514.

Step S514: Using the input image or the output image, the computing device 10 trains a deep learning model.

One or more of steps S502 to S514 may be removed or reordered according to different needs. Step S510 may be used to implement step S110, and step S508 may be used to implement step S108.

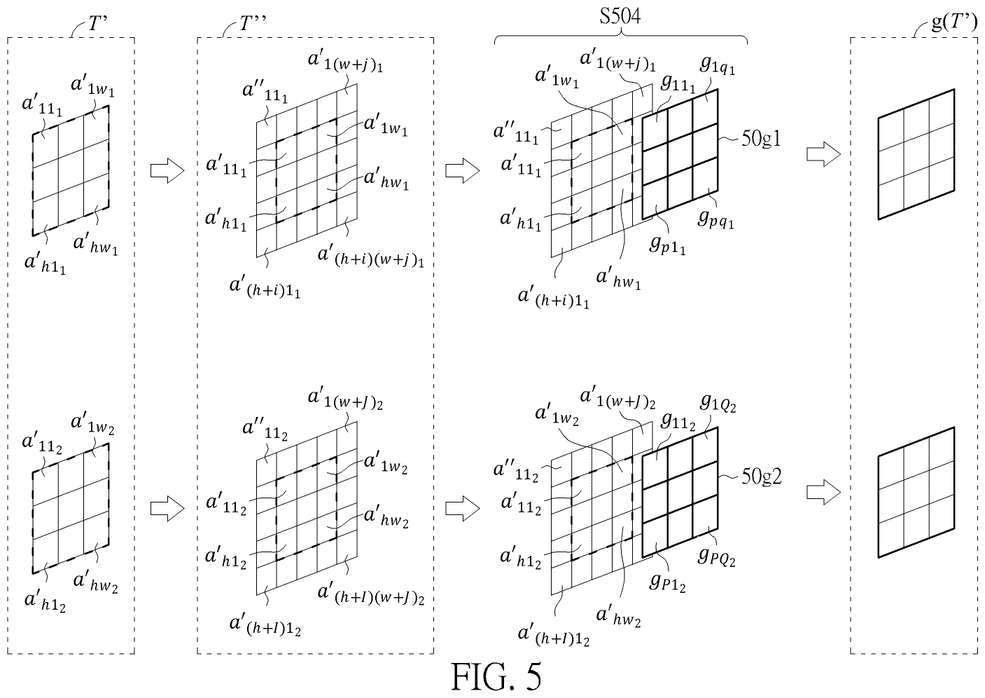

FIG. 5 is a schematic diagram of matrix generation according to an embodiment of the present invention. The matrixes T′ T″, and g(T) in FIG. 5 may be multi-dimensional arrays. Note that FIG. 5 is illustrated for 2D space. Therefore, the matrix T′ may comprise elements a′₁₁_{₂}-a′_{hw}_{₁} arranged in a 2D array and elements a′₁₁_{₂}-a′_{hw}_{₂} arranged in a 2D array. For example, the matrix T′ may be expressed as

$${T}^{′} = {[ \begin{matrix}{a}_{{11}_{1}}^{′} & ⋯ & {a}_{1 {w}_{1}}^{′} \\ ⋮ & ⋱ & ⋮ \\ {a}_{h {1}_{1}}^{′} & ⋯ & {a}_{{hw}_{1}}^{′}\end{matrix} ]}_{h \times w \times 2} .$$

This denotes that the number of rows, columns, and arrays of the matrix T′ are h, w, and 2, respectively. The matrix T″ may comprise the elements a″₁₁_{₂}-a″_{hw}_{₂} of the matrix T′ and additional elements a″₁₁_{₁}-a″_{(h+i)(w+j)}_{₁}, a″₁₁_{₂}-a″_{(h+I)(w+J)}_{₂}, which surrounds the elements a′₁₁_{₁}-a′_{hw}_{₁}, a′₁₁_{₂}-a″_{hw}_{₂}. The filter 50g1 may comprise elements g₁₁_{₁}-g_{pq}_{₁} arranged in a 2D matrix. The filter 50g2 may comprise elements g₁₁_{₂}-g_{pq}_{₂} arranged in a 2D matrix. The matrix g(T′) may comprise multiple elements arranged in two 2D matrixes. However, the present invention is not limited to 2D space, but may be applied to space of higher dimensions.

In step S502, the computing device 10 may randomly generate the first matrix (e.g., T′ or T″) according to a normal distribution. In other words, the first matrix is a random matrix, and each element of the first matrix is a random number. The elements of the first matrix may follow a normal distribution. The mean and the standard deviation of the normal distribution may be related to hyper-parameters of the first pixels (e.g., an equivalent displacement degree and an equivalent deformation degree). For example, each element of the first matrix satisfies a normal distribution with the mean equal to an equivalent displacement degree and the standard deviation equal to an equivalent deformation degree. Alternatively, all elements of the first matrix satisfy a normal distribution with the mean equal to an equivalent displacement degree and the standard deviation equal to an equivalent deformation degree. For example, if the first matrix has a total of K elements, K values are randomly sampled from a normal distribution N˜(equivalent displacement degree, equivalent deformation degree²) to constitute the first matrix. In other words, the generated first matrix may vary as the permutations or combinations of the sampled K values change. Note that even with the same mean and standard deviation, the computing device 10 may generate different first matrixes (i.e., different K values) because of randomness. As a result, in response to one single input image, the computing device 10 may output a variety of output images.

FIG. 6 is a schematic diagram of different equivalent displacement degrees according to an embodiment of the present invention. Images 610a0 to 610a50, which may be used to implement the image 210a, may correspond to equivalent displacement degrees of 0, 10, 20, 30, and 50, respectively. An equivalent displacement degree refers to the extent of the displacement of a randomly deformed region (e.g., all the first pixels) in any direction as a whole. An equivalent displacement degree may range from 0 to infinity, where 0 signifies no displacement. A larger equivalent displacement degree indicates a greater displacement magnitude (e.g., misalignment of a screw).

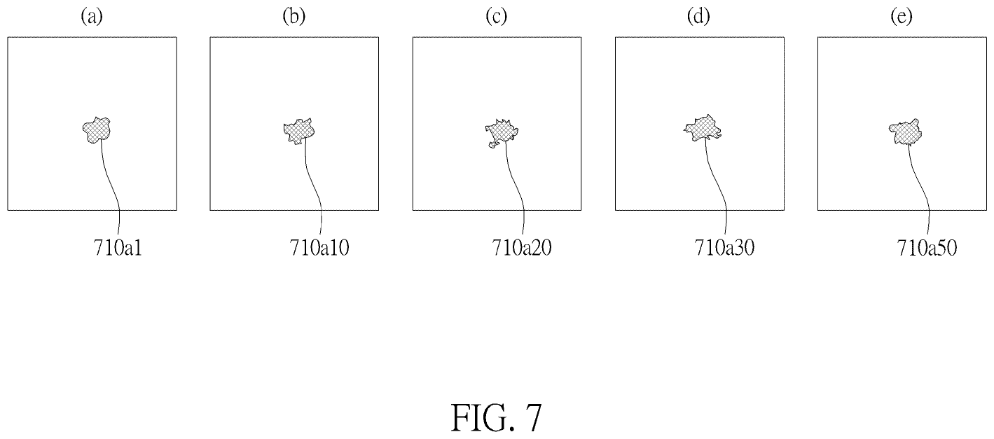

FIG. 7 is a schematic diagram of different equivalent deformation degrees according to an embodiment of the present invention. Images 710a1 to 710a50, which may be used to implement the image 210a, may correspond to equivalent deformation degrees of 1, 10, 20, 30, and 50, respectively. An equivalent deformation degree refers to the strength of deformation of a randomly deformed region (e.g., all the first pixels) as a whole. An equivalent deformation degree may range from 1 to infinity. A larger equivalent deformation degree indicates stronger deformation strength (e.g., screw thread stripping). After hyperparameter(s) (e.g., equivalent displacement degree and equivalent deformation degree) are selected, the first matrix may be randomly generated, enabling the computing device 10 to determine the deformation matrix T, which specifies how to move the pixels in the deformed region.

Please refer to FIG. 5 again. To execute step S504, in one embodiment, the computing device 10 may randomly generate the matrix T″ using a normal distribution, and use the matrix T″ as the first matrix. Alternatively, the computing device 10 may randomly generate the matrix T′ using a normal distribution, use the matrix T′ as the first matrix, and then pad the first matrix (i.e., T′) outward to create the matrix T″. In one embodiment, padding to expand outward may be achieved by zero padding, padding with an average, or copying edge elements of the matrix T′. The difference in the number of rows and columns between the matrixes T″ and T′ may be related to the stride rows and the stride columns of a filter. This ensures that after step S504, the size of the matrix g(T′) matches the size of the deformation matrix Tor T′.

In step S504, to calculate the second matrix g(T′), the computing device 10 may apply the filter (e.g., 50g1 or 50g2) to the matrix T″ (e.g., by performing convolution). This step ensures the smooth movement of each first pixel of the input image (e.g., 10IN) relative to its surrounding first pixels, and also maintains the authenticity of the final output image (e.g., 10UT1). The number of filters (e.g., 2) may be determined according to the spatial dimension (e.g., two dimensions). The filters 50g1 and 50g2 may be Gaussian filters. The standard deviation or the kernel size of the Gaussian filter(s) may be related to hyperparameter(s) of the first pixels (e.g., equivalent smoothness). For example, the computing device 10 may randomly generate the filters 50g1 and 50g2, each follows a normal distribution N˜(0, equivalent smoothness²). The sizes of the filters 50g1 and 50g2 may meet the criteria of round(equivalent smoothness×3)×2+1, where the round function is used to round values down to the nearest integer. The filters 50g1 and 50g2 may have different or identical equivalent smoothness. Even with the same equivalent smoothness, random sampling may result in differences between the filters 50g1 and 50g2. Alternatively, the filters 50g1 and 50g2 may be identical. Note that even if the second matrix g(T′) undergoes smoothing, the second matrix g(T′), essentially, remains a random matrix, with its elements retaining randomness.

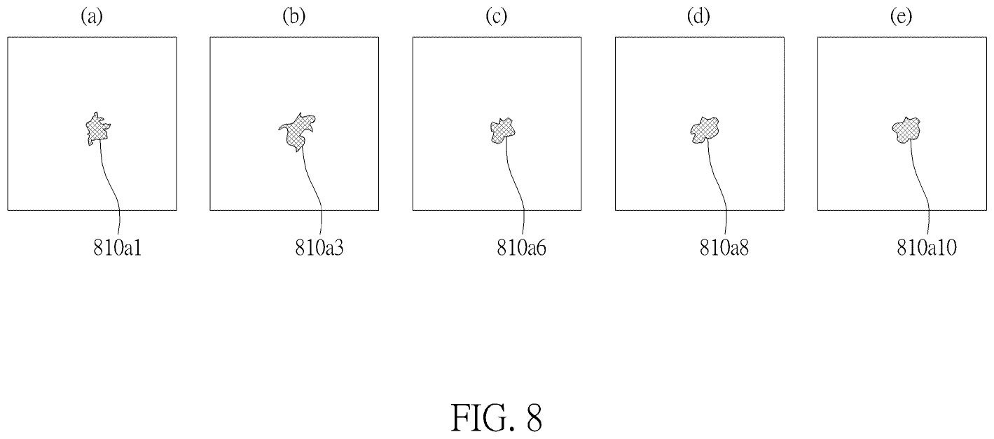

FIG. 8 is a schematic diagram of different equivalent smoothness according to an embodiment of the present invention. Images 810al to 810a10, which may be used to implement the image 210a, may correspond to equivalent smoothness of 1, 3, 6, 8, and 10, respectively, with a deformation degree equal to 50. An equivalent smoothness refers to the strength of smoothness of a randomly deformed region (e.g., all the first pixels) as a whole. An equivalent smoothness may range from 1 to infinity. A larger equivalent smoothness indicates a smoother deformation degree. In one embodiment, an equivalent displacement degree may be set to 0. Alternatively, the ratio of an equivalent deformation degree to an equivalent smoothness may be 50:8, 50:6, or within this range. This ratio may help to segment and paste a deformed region back into the input image while ensuring deformation quality.

Please refer to FIG. 5 again. In step S506, the computing device 10 may calculate the third matrix through vector integration of the matrix g(T′) (or T′). For example, the third matrix may be expressed as ∫g(T′). Note that even after vector integration, the third matrix, essentially, remains a random matrix, with its elements retaining randomness.

In another aspect, the matrix g(T′) (or T′) may be interpreted as a velocity field. After integrating the velocity field, the corresponding displacement field or deformation field (i.e., the third matrix) may be calculated. Vector integration can preserve its topology and maintain invertibility (on the transformation). Invertibility means that, for instance, taking the negative sign of the matrix g(T′) and then integrating the negative of matrix g(T′) results in ∫−g(T′). This allows that the deformed image (e.g., 210a) can be deformed again to restore the image back to its original, un-deformed state (e.g., 210).

In one embodiment, to calculate the third matrix, the matrix g(T′) (or T′) may be vector integrated with respect to time (or space). In one embodiment, the matrix g(T′) (or T′) may be a function of time. For example, the function srand( ) may be used to set a random seed, which is time-dependent and is a function of time, such that the matrix g(T′) (or T′) may be a function of time. However, the application is not limited thereto, and the matrix g(T′) (or T′) may be time-invariant. In one embodiment, the velocity field (e.g., g(T′) or T′) may involve solving an optimization problem \hat{v}=argmin_{v:ϕ}_{ₜ}₌ᵥ_{ₜ}_{(ϕ}_{ₜ}₎((∫₀¹∥vₜ∥_{V}²dt+∥I₀∘ϕ₁⁻¹−I₁∥_{L}_{²}²) to find the optimized velocity field \hat{v}. Accordingly, the corresponding displacement field is determined after vector integration of the optimized velocity field \hat{v}, where ∥vₜ∥_{V} represents an appropriate Sobolev norm on the velocity field vₜ(⋅), ∥⋅∥_{L}_{²}² represents the squared-error norm, I₀ represents the input image, I₁ represents the deformed image before optimization, and ϕ₁ represents the endpoint of a deformation path ϕₜ at a time point t=1.

In step S508, the matrix T′, g(T′), or ∫g(T′) may be used as the deformation matrix T (step S508). For example, the deformation matrix T may satisfy T=∫g(T′). Similar to the matrixes T′, T″, and g(T′), the deformation matrix Tis a multi-dimensional array corresponding to multi-dimensional space. For example, to determine the movement of each pixel in 2D space, the deformation matrix T may be expressed as

$$T = {[ \begin{matrix}{a}_{{11}_{1}} & ⋯ & {a}_{1 {w}_{1}} \\ ⋮ & ⋱ & ⋮ \\ {a}_{h {1}_{1}} & ⋯ & {a}_{{hw}_{1}}\end{matrix} ]}_{h \times w \times 2} , or \{ [ \begin{matrix}{a}_{{11}_{1}} & ⋯ & {a}_{1 {w}_{1}} \\ ⋮ & ⋱ & ⋮ \\ {a}_{h {1}_{1}} & ⋯ & {a}_{{hw}_{1}}\end{matrix} ] , [ \begin{matrix}{a}_{{11}_{2}} & ⋯ & {a}_{1 {w}_{2}} \\ ⋮ & ⋱ & ⋮ \\ {a}_{h {1}_{2}} & ⋯ & {a}_{{hw}_{2}}\end{matrix} ] \} .$$

In one embodiment, the deformation matrix T may be implemented in C++ as int T[h][w][2]. Alternatively, for 3D space, the deformation matrix T may be expressed as

$$T = {[ \begin{matrix}{a}_{11 {d}_{1}} & ⋯ & {a}_{1 {wd}_{1}} \\ ⋮ & ⋱ & ⋮ \\ {a}_{h 1 {d}_{1}} & ⋯ & {a}_{{hwd}_{1}}\end{matrix} ]}_{h \times w \times d \times 3}$$

to displace pixels in 3D space, where h, w, d, and 3 correspond to height, width, depth, and spatial dimensions, respectively. In one embodiment, the height h may be less than or equal to the image height H of the input image and greater than or equal to the maximum height of the region-of-interest SR. The width w may be less than or equal to the image width W of the input image and greater than or equal to the maximum width of the region-of-interest SR. The depth d may be less than or equal to the image depth of the input image and greater than or equal to the maximum depth of the region-of-interest SR. This is because deforming a background region 230 (shown in white) with the deformation matrix T does not alter the appearance of the output image. In one embodiment, h, H, i, I, j, J, K, n, N, m, M, p, P, q, Q, X1, X2, Y1, Y2, w, or W is a positive integer greater than or equal to 1.

In step S510, according to the deformation matrix T, the computing device 10 may generate one output image (e.g., 10UT1) corresponding to one input image (e.g., 10IN). In one embodiment, the displacements of the (first) pixels of the input image constitute one deformation matrix T. Alternatively, the displacements of the (first) pixels of the input image correspond to elements of one deformation matrix T, respectively. Alternatively, each element of one deformation matrix T represents the displacement of one (coordinate) point (i.e., one pixel) of one input image in space. Alternatively, each element of one deformation matrix T represents the coordinates, which correspond to one pixel of one input image, in one output image. For example, if an element (a₂₁_{₁}, a₂₁_{₂}) of one deformation matrix T equals (5,3), it means that after a (first) pixel of one input image located at the coordinates (2,1) is deformed, the (first) pixel is positioned at the coordinates (7,4) in one output image. Alternatively, if one element (a₂₁_{₁},a₂₁_{₂}) of one deformation matrix T equals (5,3), it means that after a (first) pixel of one input image located at the coordinates (2,1) is deformed, the (first) pixel is positioned at the coordinates (5,3) in one output image.

Since the matrix T′, g(T′), or ∫g(T′) is essentially a random matrix, the deformation matrix T may be a random deformation field, and elements of the deformation matrix T may exhibit inherent randomness. Furthermore, since the deformation matrix T may essentially be generated through a normal distribution, a large number of different random matrixes (e.g., T) can be produced, under the same set of hyperparameter(s) (i.e., the same equivalent displacement degree, the same equivalent deformation degree, and the same equivalent smoothness). Accordingly, the computing device 10 can output diverse and abundant output images in response to one single input image. Moreover, hyperparameter(s) (e.g., equivalent displacement degree, equivalent deformation degree, or equivalent smoothness) may be used to control how the deformation matrix Tis generated. In other words, by adjusting hyperparameter(s), the computing device 10 can output diverse and large amounts of output images corresponding to one single input image.

FIG. 9 is a schematic diagram of random deformation performed on an input image 90IN to generate output images 90UT1 to 90UT8 according to an embodiment of the present invention. The input image 90IN may be used to implement the input image 10IN. Any one of the output images 90UT1-90UT8 may be used to implement the output image 10UT1. In FIG. 9, cross-shaped hatching represents circuit(s) or material thereof, and triangular hatching represents slot or material thereof. The input image 90IN is an original image depicting defect(s) for an embedded wire. The output images 90UT1-90UT8 are images depicting defect(s) for the embedded wire, which are generated by the computing device 10, presenting defect scenarios where the wire is not (correctly) inserted into its slot. In other words, this application can generate defect images not only for a screw securing to a screw hole but also for other types of components.

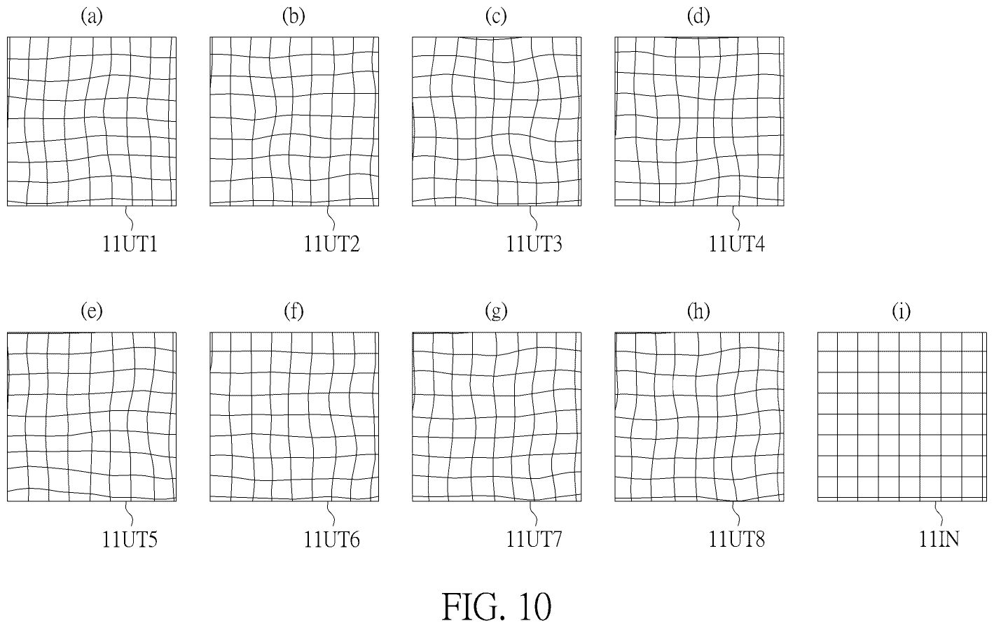

This application can generate output image(s) by displacing pixel(s) of the input image. Besides, this application can visually explain random deformation (or how to move pixel(s) of the input image). Therefore, it can ensure the interpretability and reasonableness of random deformation. For example, FIG. 10 is a schematic diagram of random deformation performed on an input image 11IN to generate output images 11UT1 to 11UT8 according to an embodiment of the present invention. The input image 11IN may be used to implement the input image 10IN. Any one of the output images 11UT1-11UT8 may be used to implement the output image 10UT1. The input image 11IN is an original standard grid image. The output images 11UT1-11UT8 are grid images randomly deformed by computing device 10. By generating a random deformation field (e.g., the deformation matrix 7) in step S108 and applying the random deformation field to a randomly deformed region (e.g., the entire input image 11IN or the region-of-interest SR) in step S110, the generated output image (e.g., 11UT1) can be used to demonstrates how each pixel of the input image (e.g., 11IN) is moved. In contrast, existing deep learning techniques cannot elucidate how image(s) is/are generated.

To verify the reasonableness of this application, experiments may be conducted to confirm whether adding different numbers of composite images (e.g., output image(s) from the computing device 10) improves the performance of a deep learning model. For example, according to Table 1, training a deep learning model using output image(s) generated by this application improves accuracy.

TABLE 1

| | | | | +10% composite | | +30% composite | |
|---|---|---|---|---|---|---|---|
| | | original dataset | | images | | images | |
| | | Number of | Number of | Number of | Number of | Number of | Number of |
| | | training | validation | training | validation | training | validation |
| | | data | data | data | data | data | data |
| Number of | Number of | 94 | 24 | 94 | 24 | 94 | 24 |
| original | normal | | | | | | |
| images | images | | | | | | |
| | Number of | 0 | 2 | 0 | 2 | 0 | 2 |
| | defective | | | | | | |
| | images | | | | | | |
| Number of | Number of | 0 | 0 | 0 | 0 | 0 | 0 |
| composite | normal | | | | | | |
| images | images | | | | | | |
| | Number of | 0 | 0 | 9 | 0 | 28 | 0 |
| | defective | | | | | | |
| | images | | | | | | |

| | | | |
|---|---|---|---|
| Area under the receiver | 47.92 | 100.00 | 100.00 |
| operating characteristic | | | |
| curve (AUROC) (%) | | | |
| Accuracy (%) | 92.31 | 100.00 | 100.00 |
| Leak (pcs) | 2 | 0 | 0 |
| Leak (ppm) | 76,923 | 0 | 0 |
| Leak (%) | 100.00 | 0.00 | 0.00 |
| Overkill (%) | 0.00 | 0.00 | 0.00 |

Furthermore, existing image generation methods (e.g., simple flipping, simple rotation, simple translation, or simple color dithering) often fail to produce sufficiently diverse defect images. For example, after (purely) rotating a stripped screw thread defect (of an image), the region of stripped screw threads remains the same shape. In other words, simple rotation alone cannot create more diverse appearance of thread stripping. In comparison, this application can generate a large number of high-authenticity and sufficiently diverse output images (e.g., defect images with different appearance of thread stripping or different distorted or damaged thread(s)) through random deformation, using only one input image. Moreover, output image(s) of this application may be combined with existing image generation method(s) to produce even more output images. In another aspect, this application is not limited to random translation deformation, but extends beyond mere random translation deformations by employing a randomly generated matrix for deformation. Therefore, the nature of displacing a pixel inherently implies (local or global) random rotation or (local) random flipping.

In addition, compared with existing deep learning technology, this application does not require a large number of images in advance. Even with just one input image, this application can create multiple output images. Moreover, this application may generate output image(s) without training a model or performing model inference, thus conserving computing resources. This application can visualize how output image(s) is/are generated, unlike the black-box operation of existing deep learning technology. More importantly, the output image(s) generated by this application can be used to train deep learning models. This overcomes the challenge faced by existing deep learning technology when lacking training data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data augmentation method, comprising:
obtaining an input image; and
generating a plurality of output images corresponding to the input image,
wherein at least one first pixel of the input image is displaced to form one of the output images, and a displacement of each of the at least one first pixel is randomized.

2. The data augmentation method of claim 1, further comprising:
generating a first matrix, wherein at least one element of the first matrix is a random number; and
determining a deformation matrix based on the first matrix, wherein the deformation matrix comprise either at least one displacement of the at least one first pixel of the input image or at least one coordinate in the output image for the at least one first pixel.

3. The data augmentation method of claim 2, wherein the at least one element of the first matrix follows a normal distribution, a mean of the normal distribution is related to an equivalent displacement degree, and a standard deviation of the normal distribution is related to an equivalent deformation degree.

4. The data augmentation method of claim 2, further comprising:
transforming the first matrix or a third matrix into a second matrix using at least one filter,
wherein determining the deformation matrix based on the first matrix comprises determining the deformation matrix based on the second matrix.

5. The data augmentation method of claim 4, wherein one of the at least one filter is a Gaussian filter, and a standard deviation or a size of the Gaussian filter is related to equivalent smoothness.

6. The data augmentation method of claim 2, further comprising:
vector-integrating the first matrix or a second matrix to generate a third matrix,
wherein determining the deformation matrix based on the first matrix comprises determining the deformation matrix based on the third matrix.

7. The data augmentation method of claim 1, further comprising:
training a deep learning model using the input image or the output images.

8. The data augmentation method of claim 1, wherein the at least one first pixel comprises all or part of pixels of the input image.

9. The data augmentation method of claim 1, further comprising:
dividing the input image into the at least one first pixel and at least one second pixel; and
performing first image processing on the at least one first pixel to form a first region image, wherein the first image processing comprises individually displacing the at least one first pixel;
wherein generating the output images corresponding to the input image comprises performing image synthesis based on the first region image and the at least one second pixel to generate one of the output images.

10. The data augmentation method of claim 9, further comprising:
performing second image processing according to the at least one second pixel to form a second region image;
wherein performing image synthesis based on the first region image and the at least one second pixel comprises combining the first region image and the second region image,
wherein the first image processing comprises removing at least one edge pixel from the at least one first pixel after displacement to form the first region image, and the at least one edge pixel is located at one or more edge of the at least one first pixel after displacement.

11. A computing device, comprising:
a storage circuit, configured to store an instruction, wherein the instruction comprises:
obtaining an input image; and
creating a plurality of output images corresponding to the input image, wherein at least one first pixel of the input image is displaced to form one of the output images, and a displacement of each of the at least one first pixel is randomized; and
a processing circuit, coupled to the storage circuit and configured to execute the instruction.

12. The computing device of claim 11, wherein the instruction further comprises:
generating a first matrix, wherein at least one element of the first matrix is a random number; and
determining a deformation matrix based on the first matrix, wherein the deformation matrix comprise either at least one displacement of the at least one first pixel of the input image or at least one coordinate in the output image for the at least one first pixel.

13. The computing device of claim 12, wherein the at least one element of the first matrix follows a normal distribution, a mean of the normal distribution is related to an equivalent displacement degree, and a standard deviation of the normal distribution is related to an equivalent deformation degree.

14. The computing device of claim 12, wherein the instruction further comprises:
transforming the first matrix or a third matrix into a second matrix using at least one filter,
wherein determining the deformation matrix based on the first matrix comprises determining the deformation matrix based on the second matrix.

15. The computing device of claim 14, wherein one of the at least one filter is a Gaussian filter, and a standard deviation or a size of the Gaussian filter is related to equivalent smoothness.

16. The computing device of claim 12, wherein the instruction further comprises:
vector-integrating the first matrix or a second matrix to generate a third matrix,
wherein determining the deformation matrix based on the first matrix comprises determining the deformation matrix based on the third matrix.

17. The computing device of claim 11, wherein the instruction further comprises:
training a deep learning model using the input image or the output images.

18. The computing device of claim 11, wherein the at least one first pixel comprises all or part of pixels of the input image.

19. The computing device of claim 11, wherein the instruction further comprises:
dividing the input image into the at least one first pixel and at least one second pixel; and
performing first image processing on the at least one first pixel to form a first region image, wherein the first image processing comprises individually displacing the at least one first pixel;
wherein creating the output images corresponding to the input image comprises performing image synthesis based on the first region image and the at least one second pixel to generate one of the output images.

20. The computing device of claim 19, wherein the instruction further comprises:
performing second image processing according to the at least one second pixel to form a second region image;
wherein performing image synthesis based on the first region image and the at least one second pixel comprises combining the first region image and the second region image,
wherein the first image processing comprises removing at least one edge pixel from the at least one first pixel after displacement to form the first region image, and the at least one edge pixel is located at one or more edge of the at least one first pixel after displacement.
